(19) United States
(12) Patent Application Publication
(10) Pub. No.: US 2025/0067049 A1
(43) Pub. Date: Feb. 27, 2025

(54) PROCESS OF PRODUCING TILES AND SHEETS

(71) Applicants: Luiz Albano Rodelli BERGAMASCHI, Curitiba-Paraná (BR); Jeferson Roberto STANGE, Curitiba-Paraná (BR)

(72) Inventors: Luiz Albano BERGAMASCHI, Curitiba-Paraná (BR); Jeferson Roberto STANGE, Curitiba-Paraná (BR); Deodato Plinio STANGE, Curitiba-Paraná (BR)

(21) Appl. No.: 18/725,644

(22) PCT Filed: Dec. 6, 2022
(86) PCT No.: PCT/BR2022/050483

§ 371 Date: Jun. 28, 2024

(30) Foreign Application Priority Data
Jan. 5, 2022 (BR) 1320220001935

(51) Int. Cl. E04D 1/20; B29C 70/36; B29C 70/54

(52) U.S. Cl. CPC E04D 1/20; B29C 70/36; B29C 70/546

(57) ABSTRACT

The present Certificate of Addition invention describes an improvement in the production process of a construction product, where the components that make up the final product are initially incorporated into the resins. In this way, the mixture of fibers and resins is uniform throughout the process, reducing the time it takes to manufacture the final product.

### FIELD OF INVENTION

Invention patent BR102019018479-5, filed on Sep. 5, 2019, refers to the production process of a material for construction, as well as its composition containing fibers and resins and its applications. More precisely, the material is corrugated tiles and sheets made from the addition of resins along with sheets of plant, mineral, or synthetic fibers.

The present invention of the Addition Certificate involves improving the production process of construction material.

The original application filed under n° BR102019018479-5 reports compositions consisting of at least one component of phenolic, formaldehyde or melamine resin and at least one component of natural or synthetic fiber, suitable as a thermosetting matrix, for obtaining semi-finished products and laminates of hardened fibers, commonly called composites. The plant fiber sheets are dipped in the resin, which can be petroleum-based or plant-based, until the sheets absorb the resin. Once the sheets of plant fibers have absorbed the resin(s), they are dried, juxtaposed and pressed at the polymerization temperature of these resins to form corrugated sheets (in the case of roof tiles) or flat sheets (in the case of slabs).

This Certificate of Addition refers to an improvement in the manufacturing process of construction material, as it results in a more homogeneous and uniform product, as well as reducing costs and saving time in the production process.

In the process described in BR102019018479-5, paper scraps are placed in a Hydra-pulper along with other plant, synthetic, mineral and/or metallic fibers, shredded, mixed with water, dried and pressed, spread out on a screen and then dipped into the resin, which can be petroleum-derived or plant-derived. Once the plant fiber sheets have absorbed the resin(s), they are dried, juxtaposed and pressed.

Unlike this Certificate of Addition, at the beginning of the manufacturing process the resin is already mixed with the fibers, thus obtaining a more homogeneous product and, consequently, one with greater resistance to compression, rupture, and shear.

The introduction of this new process showed superior performance with the final compound complying with international requirements, with a maximum load of over 450 N, in humid conditions.

### Elements of the Invention

The use of fibers to produce materials is a renewable, biodegradable and low-cost alternative. Fibers generate compounds with good recyclability. The present invention deals with the use of natural and synthetic fibers in the construction industry, using resin-bonded fibers as the raw material, forming a compound.

Compound materials can be defined as materials made up of two or more constituents with different compositions, structures, and properties and which are separated by an interface. The main objective in producing compounds is to combine different materials to produce a single device with properties superior to those of the unitary components (AL-QURESHI, 2002).

The objective of obtaining fibrous compounds for the production of tiles and sheets is due to the fact that the long fibers of certain materials are much more resistant and stronger than a specimen constructed with the material in its natural form.

The properties of compounds are mainly controlled by the properties of their constituents, their distribution, dispersion, their interaction with the matrix as well as their shape and size.

The results obtained were compared with corrugated roof tiles and laminated sheets used in construction, with the advantage of reducing environmental impacts. The final product showed good geometric characteristics and the experimental tests demonstrated an overall stiffness which was 80% higher at the same market price.

### DETAILED DESCRIPTION OF THE INVENTION

The present invention describes an improvement in the production process of a construction product. When the natural and synthetic fibers are separated, water-soluble resins are added to the Hydrapulper-type equipment or to any other disaggregating equipment that is responsible for disaggregating or breaking up the paper or cellulose scraps in order to form a homogeneous mass. These resins can also be added in a dough tank, where the fibers are already partially or completely purified.

The Hydrapulper works like a giant blender, usually cylindrical in shape. By agitating the fibers in water and adding phenolic and/or melamine resins at a concentration of 5% to 30% by weight, in a continuous process, the paper fibers are detached, forming a resinous cellulose pulp, which may contain some aggregates of plastic materials and metals.

The mixture of fibers and resin then goes through the drying phase, forming a composite for the subsequent production of tiles and sheets, through polymerization in the press.

Flat and/or corrugated tiles and sheets are produced from these composites using a low-energy production process, including common vibrations and curing.

The compounds are made up of sheets of plant fibers obtained from paper scraps or discarded from paper and sugar cane mills (plant waste), and may also contain mineral fibers (metal ribbons) or synthetic fibers, agglomerated with resins derived from petroleum or vegetables, in corrugated or flat formats.

The solution of water and resin has a ratio of 90% to 95% by weight to 5% to 10% by weight of fibers.

The addition of the resin and water solution to the natural or synthetic fibers at the beginning of the manufacturing process results in a more homogeneous and uniform material, as well as reducing the manufacturing time of the final product, since the impregnation and equalization steps of the original process are discarded.

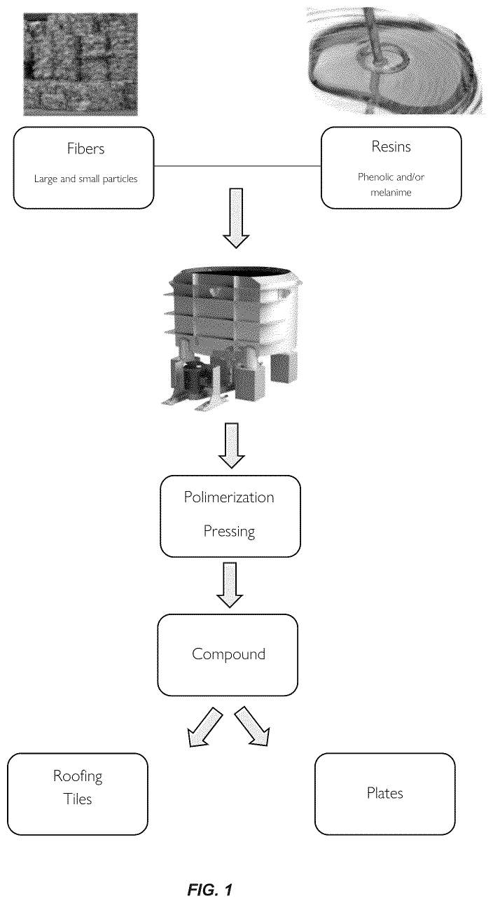

FIG. 1 shows a schematic of the process, which can be summarized as follows:
Phase 1: Mix the natural or synthetic fibers in water;
Phase 2: add water-soluble phenolic and melamine resins to Phase 1 in disaggregating equipment;
Phase 3: dry Phase 2 to form the compound;
Phase 4: produce roofing tiles and sheets with the compound.

What is claimed is:

1. TILE AND SHEET PRODUCTION PROCESS, characterized by comprising the following stages:
Phase 1: Mix the natural or synthetic fibers in water;
Phase 2: add water-soluble phenolic and melamine resins to Phase 1 in disaggregating equipment;
Phase 3: dry Phase 2 to form the compound;
Phase 4: produce roofing tiles and sheets with the compound.

2. PRODUCTION PROCESS according to claim 1, is characterized by the phenolic and/or melamine resins being at a concentration of 5% to 30% in weight.

3. PRODUCTION PROCESS according to claims 1 and 2, characterized by the solution of water and resin being in the proportion of 90% to 95% in weight to 5% to 10% in weight of fibers.

4. PRODUCTION PROCESS according to claim 1, characterized by the solution of water and resin being in the proportion of 90% to 95% in weight to 5% to 10% in weight of fibers.
